(19) United States
(12) Patent Application Publication
(10) Pub. No.: US 2019/0282947 A1
(43) Pub. Date: Sep. 19, 2019

(54) MISTER FOR PORTABLE MORTAR MIXER

(71) Applicant: Gary Weckbaugh, Topeka, KS (US)

(72) Inventor: Gary Weckbaugh, Topeka, KS (US)

(21) Appl. No.: 16/292,707

(22) Filed: Mar. 5, 2019

Related U.S. Application Data
(60) Provisional application No. 62/642,396, filed on Mar. 13, 2018.

(51) Int. Cl. B01D 47/06

(52) U.S. Cl. CPC B01D 47/06; B05B 3/022

(57) ABSTRACT

A mister for a portable mortar mixer. The mister for the portable mortar mixer includes an inlet hose designed to secure to a spigot or other water source. A primary interface is in operable connection with the inlet hose, so that water will flow from the water source to the primary interface. Outlet hoses extend from the primary interface opposite of the inlet hose so that water is directed from the primary interface to the outlet hoses. Each outlet hose has a misting nozzle that is designed to spray a water mist over the active mixing site of a mortar mixer. Additionally, each outlet hose has a fastener designed to secure the outlet hose to a mortar mixer.

### CROSS REFERENCE TO RELATED APPLICATIONS

This application claims the benefit of U.S. Provisional Application No. 62/642,396 filed on Mar. 13, 2018. The above identified patent application is herein incorporated by reference in its entirety to provide continuity of disclosure

### BACKGROUND OF THE INVENTION

The present invention relates to a mister for a portable stand mixer. More specifically, the present invention relates to a system of hoses configured to attach to a mixing device, such as a portable stand mixer, such that water can be misted above the active area of the misting device.

Mixing components, such as concrete, is an important aspect of any construction project. However, some compounds that require mixture may result in the release of mortar dust into the area surrounding the mixing device. Mortar dust exposure is regulated by the Occupational Safety and Health Administration, as excessive exposure to mortar dust may result in an increased risk of lung diseases, such as lung cancer. More effectively managing and minimizing mortar dust exposure is a primary issue facing the construction industry. Currently available methods are ineffective and do not adequately reduce mortar dust exposure to desired levels.

Therefore, there is a defined need amongst the known art for a device that more effectively and efficiently prevents an excessive amount of mortar dust from rising from a mixing device. Furthermore, there is a need for a device that is removable and reusable such that the mortar dust protection provided by the device can be usable upon a number of different mixing devices.

### SUMMARY OF THE INVENTION

In view of the foregoing disadvantages inherent in the known types of misting devices now present in the known art, the present invention provides a mister device wherein the same can be utilized for providing convenience for the user when preventing the rise up of mortar dust while using a mixing device.

The present system comprises an inlet hose having a first end and a second end. The first end is attached to a primary interface. The second end is configured to attach to a water source, such as a spigot. A plurality of outlet hoses extends from the primary interface. Each outlet hose comprises a misting nozzle disposed on an end thereof, oppositely the primary interface. A plurality of fasteners is attached to each misting nozzle of the plurality of misting nozzles, such that each misting nozzle can be secured to a mixing device.

In another embodiment, the plurality of outlet hoses comprises a first outlet hose and a second outlet hose, such that two misting nozzles are provided.

In a further embodiment, the plurality of outlet hoses comprises a first outlet hose and a second outlet hose, wherein each of the first outlet hose and the second outlet hose comprise a secondary interface disposed thereon with a pair of secondary hoses extending from the secondary interface, such that four misting nozzles are provided.

In yet another embodiment, the present system comprises a fastener consisting of a threaded bolt and a wing nut, such that the mister for a portable mortar mixer can be secured to a device having a plurality of mounting apertures.

In yet a further embodiment, the present system further comprises a bracket, wherein the bracket comprises an elongated body having a pair of offset members disposed on a pair of ends of the elongated body, wherein the first offset member comprises an interface for the fastener and the second offset member comprises a receiver for the misting nozzle.

In another embodiment, the present invention comprises a plurality of misting nozzles that are removable securable upon the bracket, such as to provide enhanced utility to the user.

In a further embodiment, the present invention comprises a bracket that is freely rotatable about the fastener, such that the angle at which the misting nozzle is pointed is adjustable by the user.

In yet another embodiment, the present invention comprises a primary interface fastener, such that the primary interface can be secured upon a mixing device to provide convenience for the user.

In yet a further embodiment, the present invention comprises a plurality of misting nozzles attached to the plurality of outlet hoses at ninety-degree angles, such as to enable more effective arrangement of the misting nozzles by the user.

In another embodiment, the present invention comprises an adapter disposed on an external surface of the primary interface, wherein the adapter is configured to adjust the flow rate of water through the primary interface.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mister for a portable mortar mixer.

FIG. 2 shows a close-up view of a fastener of an embodiment of the mister for a portable mortar mixer.

FIG. 3 shows a perspective view of an embodiment of the mister for a portable mortar mixer in use.

### DETAILED DESCRIPTION OF THE INVENTION

Reference is made herein to the attached drawings. Like reference numerals are used throughout the drawings to depict like or similar elements of the mister for a portable mortar mixer. The figures are intended for representative purposes only and should not be considered to be limiting in any respect.

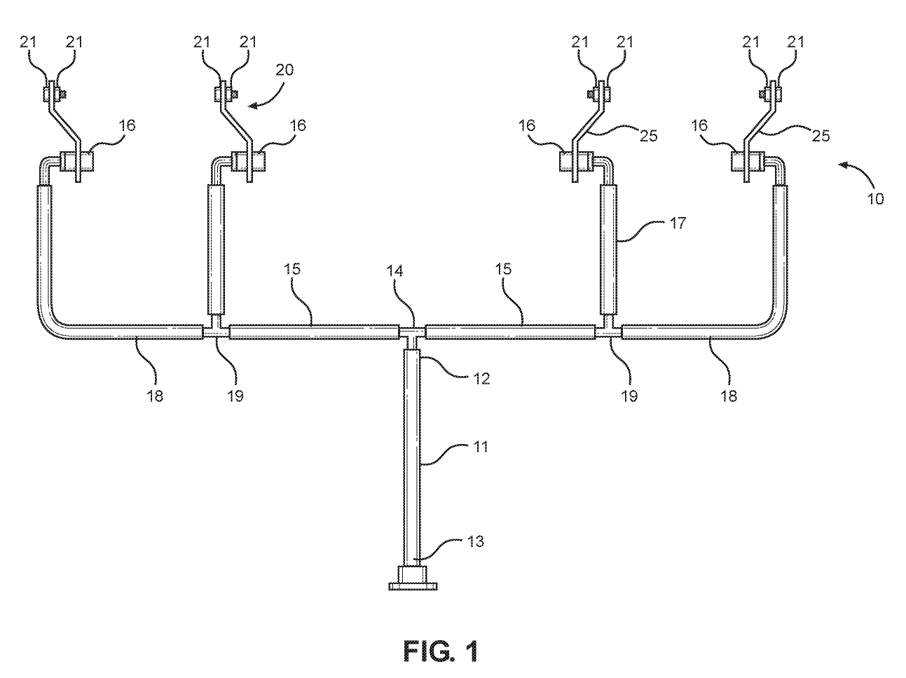

Referring now to FIG. 1, there is shown a perspective view of an embodiment of the mister for a portable mortar mixer. The mister for a portable mortar mixer 10 comprises an inlet hose 11. The inlet hose 11 has a first end 12 disposed oppositely a second end 13. The inlet hose 11 is hollow such as to allow a liquid, such as water, to flow therethrough. The second end 13 of the inlet hose 11 is configured to operably connect to a fluid source, such as a spigot. In one embodiment, the inlet hose 11 is made of a flexible material, such that it may more easily be wrapped or otherwise secure to the mixer.

The first end 12 of the inlet hose 11 is in operable communication with a primary interface 14. In the illustrated embodiment, the primary interface 14 is a tee fitting. The primary interface 14 is configured to transport fluid from a fluid source at the second end 13 of the inlet hose 11 to a plurality of outlet hoses 15 extending from the primary interface 14.

In another embodiment, the primary interface 14 comprises an adapter on an external surface of the primary interface 14. The adapter is configured to adjust the flow rate of water through a plurality of outlet hoses 15. In one embodiment, the adapter allows for the flow rate to be changed on either side of the primary interface 14.

The plurality of outlet hoses 15 is configured to receive fluid from the primary interface 15 and transport the fluid to the plurality of misting nozzles 16. In the illustrated embodiment, the plurality of outlet hoses 15 comprises a first outlet hose 17 and a second outlet hose 18. Furthermore, in the illustrated embodiment, the first outlet hose 17 and the second outlet hose 18 are in operable communication with the primary outlet hose 15 via a tee divider 19. The tee divider 19 ensures that water is evenly divided between the first outlet hose 17 and the second outlet hose 18.

The plurality of misting nozzles 16 are each attached to each outlet hose of the plurality of outlet hoses 15. Each misting nozzle of the plurality of misting nozzles 16 is configured to emit the fluid, such as water, in a misting pattern. The misting pattern ensures that the surface area of the fluid released is maximized over a targeted area, such as a receiving portion of a portable mortar mixer. With a greater surface area of a released fluid, the more effective the plurality of misting nozzles 16 are at preventing the release of mortar dust from the portable mortar mixer.

In the illustrated embodiment, each misting nozzle of the plurality of misting nozzles 16 is secured to each outlet hose 15 at a ninety degree angle. Through this configuration, fluid flow through the misting nozzle will be constant and unimpeded, such as may result if a kink were to exist in the outlet hose 15. In a further embodiment, the ninety-degree angle is movable or flexible.

Each misting nozzle of the plurality of misting nozzles 16 comprises a fastener 20. The plurality of fasteners 20 is configured to secure each misting nozzle of the plurality of misting nozzles 16 to the receiving end of the portable mortar mixer. In the illustrated embodiment, the fastener 20 comprises a threaded bolt 21 in operable communication with a wingnut 22. The threaded bolt 21 is configured to be inserted through an aperture, such as an aperture in a receiving apparatus of a portable mortar mixer. The wingnut 22 is configured to be movable across a threading of the threaded bolt 21, such that the position of the misting nozzle of the plurality of misting nozzles 16 can be secured and released by the action of the wingnut 22 upon the threaded bolt 21.

Furthermore, in the illustrated embodiment, the fastener comprises a bracket 25. The bracket 25 is configured to secure each fastener of the plurality of fasteners 20 to each misting nozzle of the plurality of misting nozzles 16.

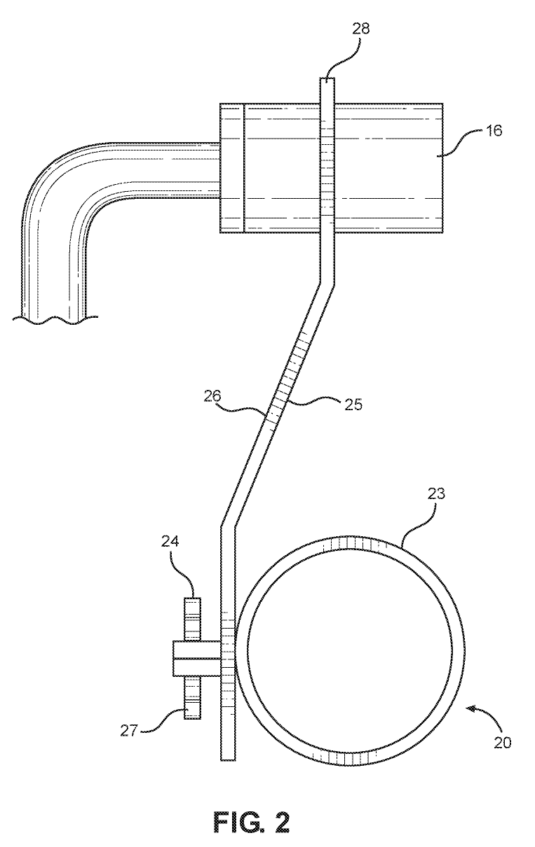

Referring now to FIG. 2, there is shown a close-up view of a fastener of an embodiment of the mister for a portable mortar mixer. In the illustrated embodiment, the fastener comprises a ring clamp 23 in operable connection with a tightener 24. The bracket 25 comprises an elongated body 26 having a pair of offset end members 27, 28. A first offset end member 27 comprises an interface for the fastener 20. Each bracket 25 is freely rotatable around the fastener 20, such that the position of the misting nozzle 16 can be freely adjusted by rotation of the bracket 25.

A second offset end member 28 comprises a receiver for the misting nozzle 16. In one embodiment, the receiver is configured to allow each misting nozzle of the plurality of misting nozzles 16 to be freely removable from the bracket 25. In another embodiment, the bracket 25 is pivotable around each misting nozzle 16 to provide enhanced maneuverability and position of the misting nozzles 16.

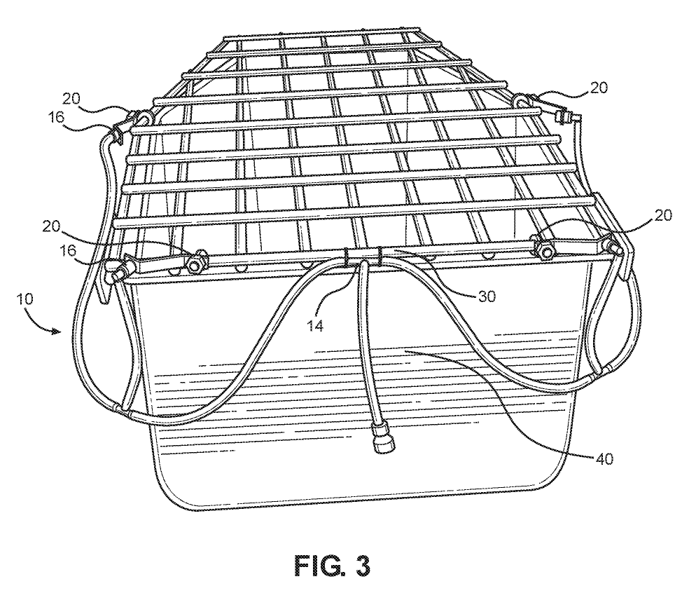

Referring now to FIG. 3, there is shown a perspective view of an embodiment of the mister for a portable mortar mixer in use. In the illustrated embodiment, the primary interface 14 comprises a primary interface fastener 30. The primary interface fastener 30 is configured to attach to the mixing device. In one embodiment, the the mister for a portable mortar mixer 10 is attached to a portable mortar mixer 40 via the action of the plurality of fasteners 20. Each of the misting nozzles of the plurality of misting nozzles 16 is oriented such that a misting of fluid is released over the receiving area of the portable mortar mixer 40.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mister for a portable mortar mixer, comprising:
an inlet hose having a first end and a second end;
a primary interface attached to the inlet hose at the first end;
a plurality of outlet hoses extending from the primary interface;
a plurality of misting nozzles attached to each outlet hose of the plurality of outlet hoses opposite of the primary interface;
a plurality of fasteners attached to each misting nozzle of the plurality of misting nozzles configured to secure the misting nozzles to a portable mortar mixer.

2) The mister for a portable mortar mixer of claim 1, wherein the plurality of outlet hoses comprises a first outlet hose and a second outlet hose.

3) The mister for a portable mortar mixer of claim 2, wherein each of the first outlet hose and the second outlet hose comprises a secondary interface on each of the first outlet hose and the second outlet hose, wherein a pair of secondary hoses extend from the second interface.

4) The mister for a portable mortar mixer of claim 1, wherein each fastener comprises a threaded bolt and a wingnut.

5) The mister for a portable mortar mixer of claim 1, wherein each fastener comprises a bracket.

6) The mister for a portable mortar mixer of claim 5, wherein the bracket comprises an elongated body having a pair of offset end members, wherein a first offset end member comprises an interface for the fastener and the second offset end member comprises a receiver for the misting nozzle.

7) The mister for a portable mortar mixer of claim 5, wherein each misting nozzle of the plurality of misting nozzles is freely removable from the bracket.

8) The mister for a portable mortar mixer of claim 5, wherein each bracket is freely rotatable around each fastener.

9) The mister for a portable mortar mixer of claim 1, wherein the primary interface comprises primary interface fastener.

10) The mister for a portable mortar mixer of claim 1, wherein each misting nozzle of the plurality of misting nozzles is secured to each outlet hose at a ninety-degree angle.

11) The mister for a portable mortar mixer of claim 1, wherein the primary interface comprises an adapter on an external surface thereof, wherein the adapter is configured to adjust the flow rate of water through the plurality of outlet hoses.
